(19) United States
(12) Patent Application Publication
(10) Pub. No.: US 2014/0140070 A1
(43) Pub. Date: May 22, 2014

(54) LED LAMP

(71) Applicant: Ching-Tien Lin, Taichung City (TW)

(72) Inventor: Ching-Tien Lin, Taichung City (TW)

(21) Appl. No.: 13/804,953

(22) Filed: Mar. 14, 2013

(30) Foreign Application Priority Data
Nov. 16, 2012 (TW) 101222262

(51) Int. Cl. F21V 13/04

(52) U.S. Cl. CPC F21V 13/04
USPC 362/309; 362/308

(57) ABSTRACT

An LED lamp includes a base, a driving circuit board mounted to the base, a lighting module, a light guide member and a reflecting member. The lighting module includes a plurality of light emitting diodes that are disposed on and electrically connected to the driving circuit board. The light guide member has an open end portion that is connected to the base, that corresponds in position to the light emitting diodes, and that is disposed for receiving light emitted from the light emitting diodes, and a close end portion that is opposite to the open end portion. The reflecting member is disposed in and abuts against the light guide member for reflecting the light transmitted from the light guide member.

### CROSS-REFERENCE TO RELATED APPLICATION

This application claims priority of Taiwanese Patent Application No. 101222262, filed on Nov. 16, 2012.

### BACKGROUND OF THE INVENTION

1. Field of the Invention

The invention relates to a lamp, more particularly to an LED lamp.

2. Description of the Related Art

In recent years, matured light emitting diode (abbreviated as LED hereinafter) technology has been applied to a variety of illuminating apparatuses due to advantages such as having high illuminating efficiency, long service life, fast response, and high reliability.

Referring to FIG. 1, a conventional LED lamp includes a base 11, a plurality of LEDs 12, and an opaque light cover 13 for covering the LEDs 12. By utilizing the light cover 13, the conventional LED lamp is capable of softening the glare of the light illuminated from the LEDs 12. However, due to the limited illuminating angle of the LED as a point source of light, a relatively great number of LEDs is needed for producing an even illumination distribution, and thus generating a relatively high yet undesirable amount of heat.

### SUMMARY OF THE INVENTION

Therefore, the object of the present invention is to provide an LED lamp to overcome the aforesaid drawbacks.

Accordingly, an LED lamp of the present invention includes:
a base;
a driving circuit board mounted to the base;
a lighting module including a plurality of spaced-apart LEDs that are annularly disposed on and electrically connected to the driving circuit board;
a light guide member having an open end portion that is connected to the base, that corresponds in position to the LEDs, and that is disposed for receiving light emitted from the LEDs, and a close end portion that is opposite to the open end portion; and
a reflecting member disposed in the light guide member and abutting against an inner surface of the light guide member for reflecting the light transmitted from the light guide member.

### BRIEF DESCRIPTION OF THE DRAWINGS

Other features and advantages of the present invention will become apparent in the following detailed description of the preferred embodiment with reference to the accompanying drawings, of which:

FIG. 1 is a cutaway perspective view of a conventional LED lamp;

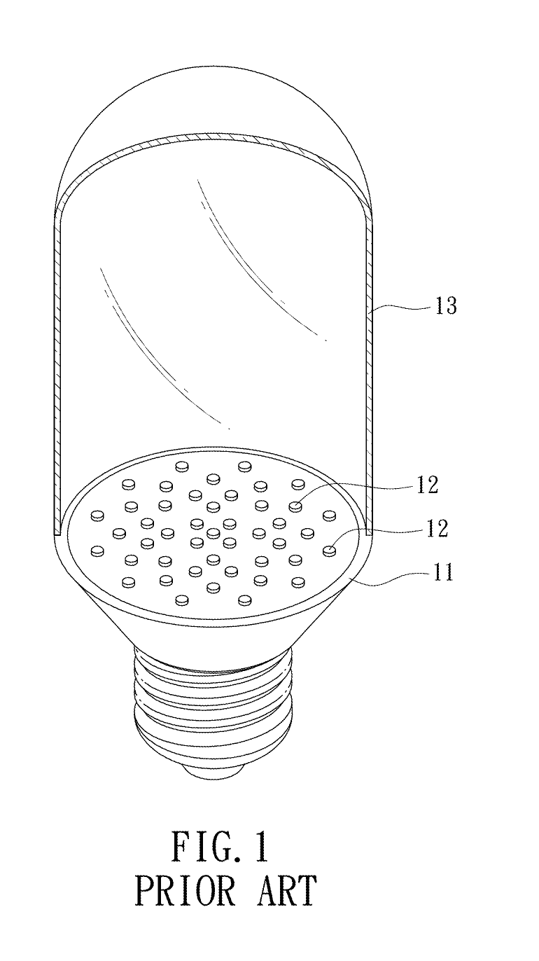

FIG. 2 is a sectional view of a preferred embodiment of an LED lamp according to the present invention;

FIG. 3 is a top view of a driving circuit board and LEDs of the preferred embodiment;

FIG. 4 is an exploded sectional view of a light guide member and a reflecting member of the preferred embodiment;

FIG. 5 is a sectional view of the light guide member and the reflecting member of the preferred embodiment;

FIG. 6 is a bottom view of the light guide member and the reflecting member of the preferred embodiment;

FIG. 7 is a sectional view of a variation of the preferred embodiment;

FIG. 8 is a sectional view of another variation of the preferred embodiment;

FIG. 9 is a fragmentary exploded sectional view of a base, the light guide member and the reflecting member of the variation of the preferred embodiment shown in FIG. 8; and

FIG. 10 is a sectional view of the base, the light guide member and the reflecting member of the variation of the preferred embodiment shown in FIG. 8.

### DETAILED DESCRIPTION OF THE PREFERRED EMBODIMENT

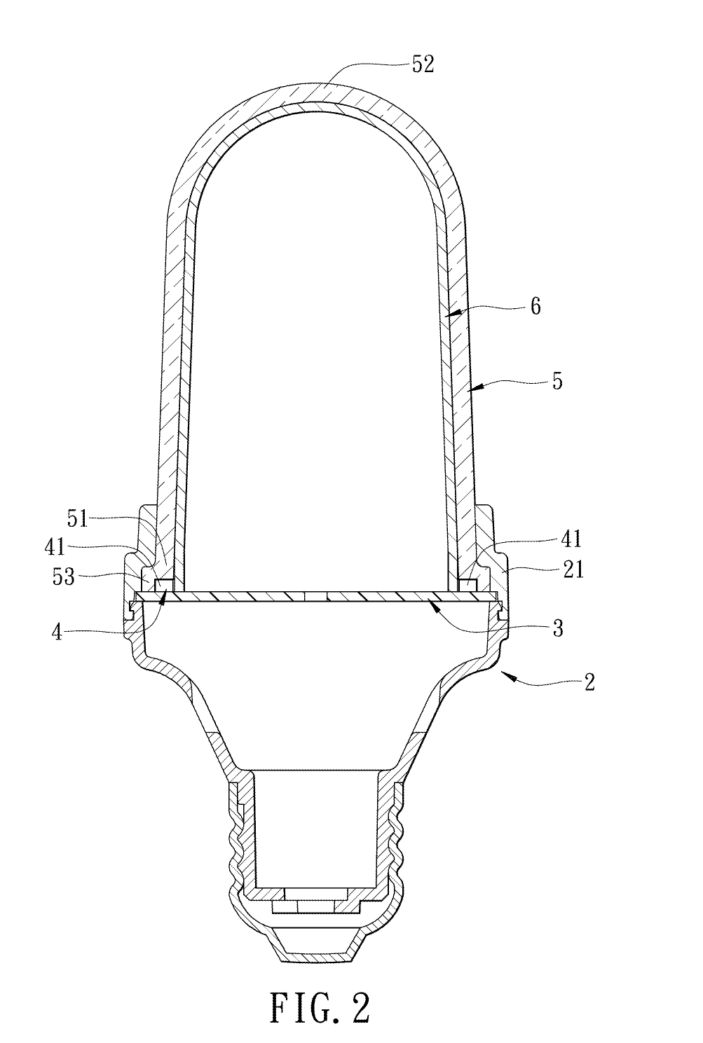

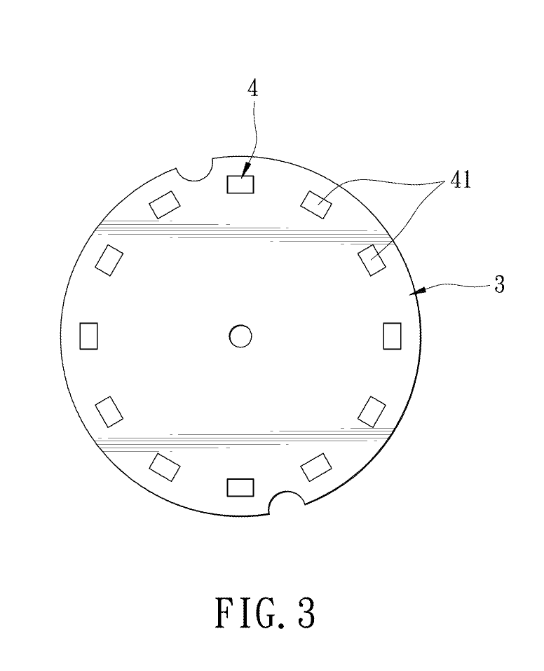

Referring to FIGS. 2 and 3, the preferred embodiment of an LED lamp according to the present invention is disclosed to include a base 2, a driving circuit board 3, a lighting module 4, a light guide member 5, and a reflecting member 6.

The driving circuit board 3 is mounted to the base 2.

The lighting module 4 includes a plurality of spaced-apart LEDs 41 annularly disposed on and electrically connected to the driving circuit board 3.

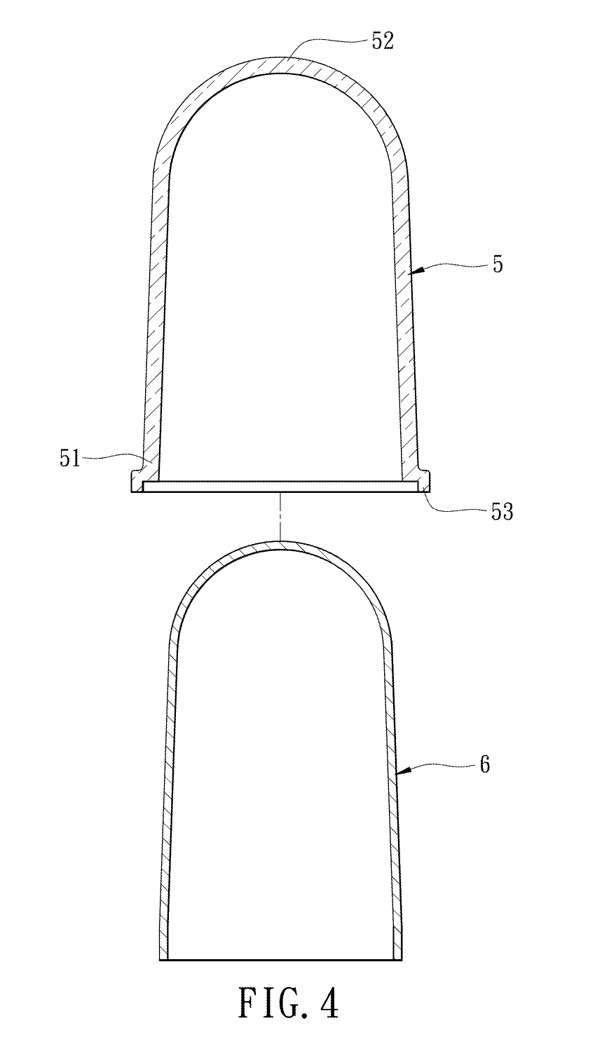

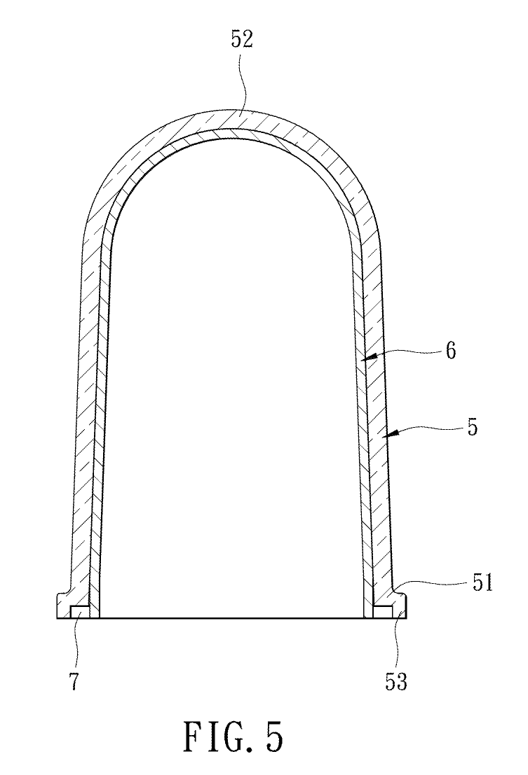

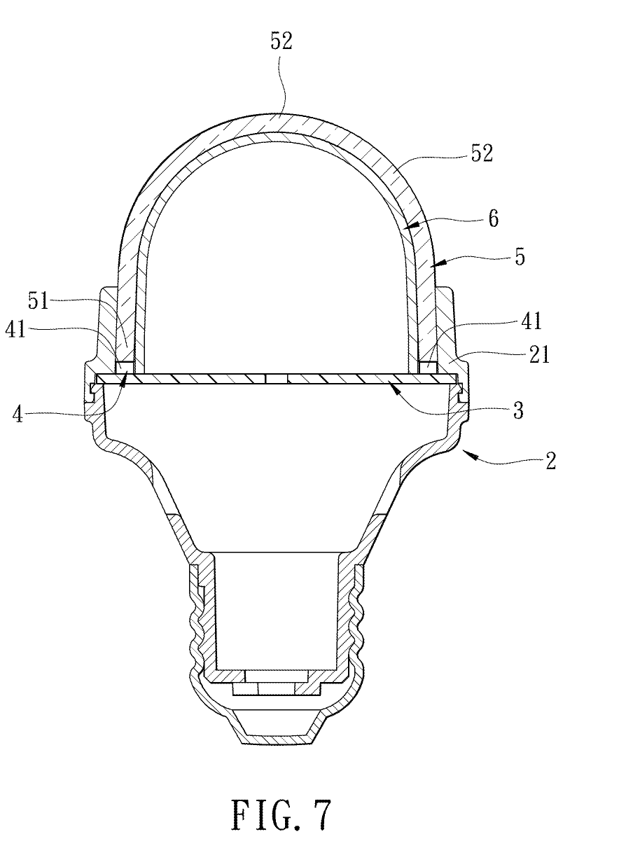

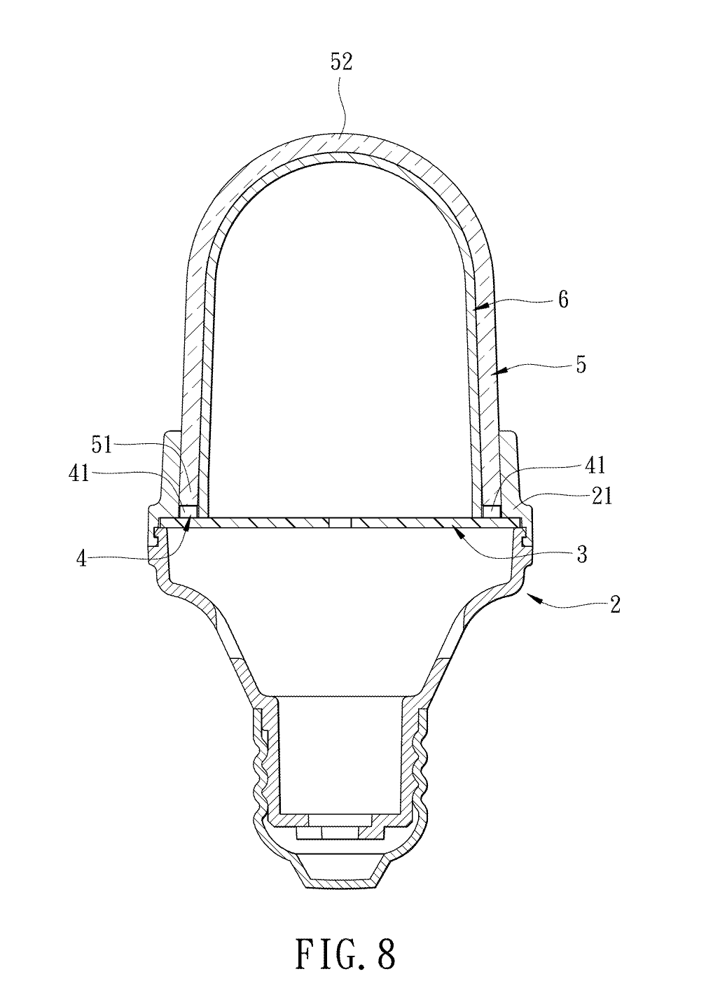

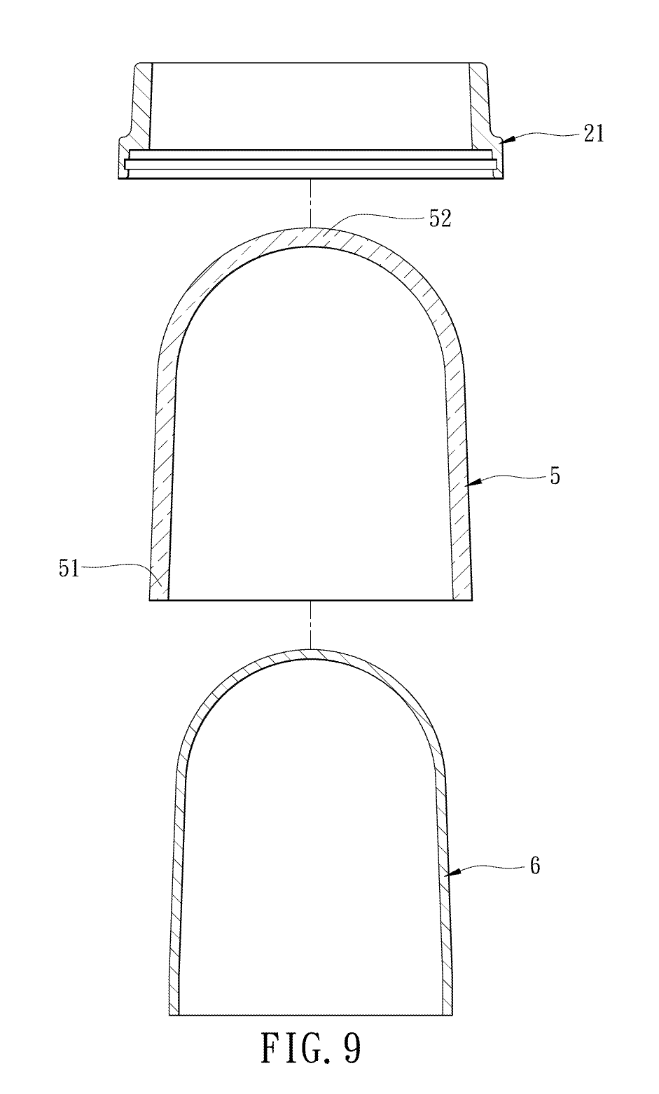

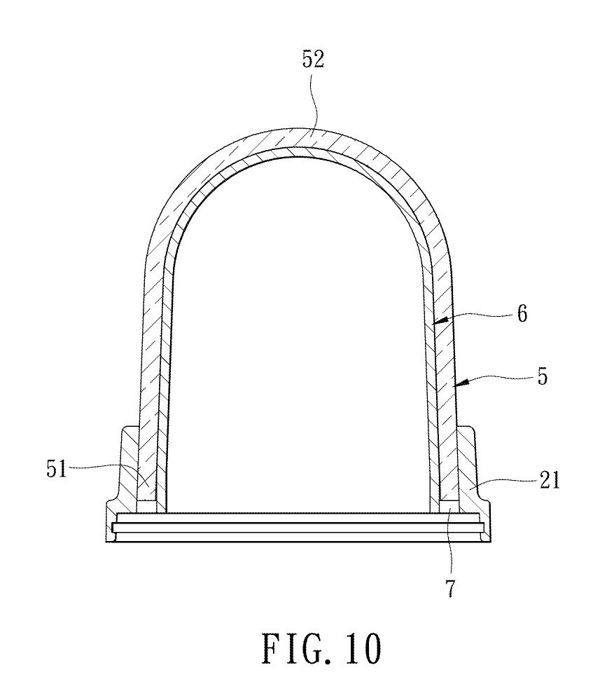

As shown in FIG. 2 and further referring to FIGS. 4 and 5, the light guide member 5 has an open end portion 51 that abuts against an abutting portion 21 of the base 2, that corresponds in position to the LEDs 41, and that is disposed for receiving light emitted from the LEDs 41, and a close end portion 52 that is opposite to the open end portion 51. In this preferred embodiment, the light guide member 5 is transparent and colorless. However, the light guide member 5 may be colored so as to transform the color of the light emitted from the LEDs 41 (i.e., the color of the light guide member 5 is not limited in other embodiments of the present invention). The light guide member 5 has a cross-sectional inner diameter that decreases gradually from the open end portion 51 to the close end portion 52, and the shape of the close end portion 52 is hemi-spheroidal. However, the shape of the close end portion 52 and the distance between the open and close end portions 51, 52 are not limited in other embodiments of the present invention (see FIGS. 7 and 8). In this embodiment, the light guide member 5 further has a stepped protruding segment 53 at the open end portion 51 and protruding outwardly, and the abutting portion 21 of the base 2 (see FIGS. 2, 4, 5 and 6) has a configuration matching with that of the protruding segment 53 and abuts against the protruding segment 53. Consequently, the light guide member 5 is positioned relative to the base 2 through the engagement between the protruding segment 53 and the abutting portion 21. Moreover, the open end portion 51 has a cross-sectional outer diameter slightly larger than an inner diameter of the abutting portion 21 so as to abut firmly against the abutting portion 21 of the base 2. The light guide member 5 may be positioned without the existence of the protruding segment 53 other variations of the preferred embodiment (see FIGS. 7, 8, 9 and 10).

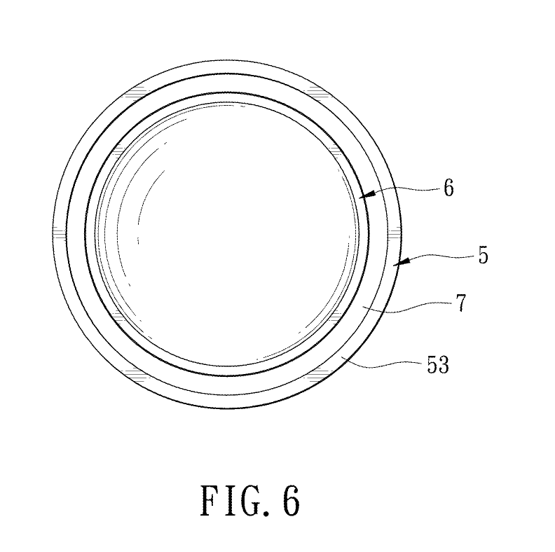

As shown in FIGS. 2 and 4, the reflecting member 6 abuts against an inner surface of the light guide member 5 for reflecting the light transmitted from the light guide member 5. As shown in FIGS. 5 and 6, the open end portion 51 of the light guide member 5 and the reflecting member 6 cooperatively define an annular groove 7 for receiving the LEDs 41. However, as shown in FIGS. 7 to 10, the annular groove 7 may be defined cooperatively by the abutting portion 21 of the base 2, the light guide member 5 and the reflecting member 6 when the protruding segment 53 is omitted while the open end portion 51 is spaced apart from the driving circuit board 3. In this embodiment, the reflecting member 6 is white and made of a plastic material, but is not limited in this regard in other embodiments of the present invention.

To sum up, the gradually decreasing cross-sectional inner diameter of the light guide member 5, along with the reflecting member 6, allows the light transmitted from the LEDs 41 to be transmitted or reflected within the light guide member 5 from the open end portion 51 to the close end portion 52, and to be reflected evenly and outwardly by the reflecting member 6, so as to generate an even illumination distribution of light throughout the light guide member 5. This requires fewer LEDs 41 which prevents glare of the LEDs 41.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An LED lamp comprising:
a base;
a driving circuit board mounted to said base;
a lighting module including a plurality of spaced-apart light emitting diodes that are annularly disposed on and electrically connected to said driving circuit board;
a light guide member having an open end portion that is connected to said base, that corresponds in position to said light emitting diodes, and that is disposed for receiving light emitted from said light emitting diodes, and a close end portion that is opposite to said open end portion; and
a reflecting member disposed in said light guide member and abutting against an inner surface of said light guide member for reflecting the light transmitted from said light guide member.

2. The LED lamp as claimed in claim 1, wherein said light guide member has a cross-sectional inner diameter that decreases gradually from said open end portion to said close end portion.

3. The LED lamp as claimed in claim 2, wherein said base has an abutting portion, said open end portion of said light guide member further having a protruding segment that protrudes outwardly and that abuts against said abutting portion of said base.

4. The LED lamp as claimed in claim 3, wherein said close end portion of said light guide member is hemi-spheroidal.

5. The LED lamp as claimed in claim 1, wherein said open end portion of said light guide member and said reflecting member cooperatively define an annular groove for receiving said light emitting diodes.

6. The LED lamp as claimed in claim 1, wherein said open end portion of said light guide member is spaced apart from said driving circuit board and cooperates with said reflecting member and said base to define an annular groove for receiving said light emitting diodes.

7. The LED lamp as claimed in claim 1, wherein said reflecting member is made of a plastic material.

8. The LED lamp as claimed in claim 1, wherein said reflecting member is colored.

9. The LED lamp as claimed in claim 8, wherein said reflecting member is white.
